(19) United States
(12) Patent Application Publication
(10) Pub. No.: US 2008/0286119 A1
(43) Pub. Date: Nov. 20, 2008

(54) Arrangement and method for monitoring a hydraulic system

(75) Inventors: Juri Alma, Linkoping (SE); Magnus Landberg, Linkoping (SE); Mats Kristoffersson, Linkoping (SE)

Correspondence Address: VENABLE LLP, P.O. BOX 34385, WASHINGTON, DC, 20043-9998, US

(73) Assignee: SAAB AB, Linkoping (SE)

(21) Appl. No.: 12/149,573

(22) Filed: May 5, 2008

(30) Foreign Application Priority Data
May 4, 2007 (EP) 07107569.1

(51) Int. Cl. F04B 49/00; G08B 21/18; G05D 7/00; F17D 1/00

(52) U.S. Cl. 417/43; 340/603; 137/2; 417/53; 700/282

(57) ABSTRACT

An arrangement for monitoring a supply within a platform. A sensor is arranged to generate sample values relating to a fluid characteristic variable, wherein the fluid is fed by the supply within the platform. A processor is arranged to receive a plurality of sample values from the sensor. The processor, is arranged to generate an absolute value of a difference between each of the received plurality of sample values and a subsequent associated sample value, wherein the received sample values are generated during a predetermined time period. The processor is arranged to determine an indication number corresponding to the number of the generated absolute values which are greater than a predetermined threshold value. The sample collecting process is only active when a criterion comprising a stable pump in a no load condition and all hydraulic consumers are in a resting position or close to a resting position is fulfilled. The processor is arranged to generate a piece of indication information depending upon a result of a comparison between the determined indication number and a predetermined comparison value.

### TECHNICAL FIELD

The invention relates in general to monitoring of hydraulic pumps. In particular the invention relates to monitoring of hydraulic pumps provided within a platform.

The invention also relates to a method for monitoring hydraulic pumps. In particular the invention relates to a method for monitoring hydraulic pumps within a platform. Furthermore, the invention relates to software adapted to perform steps of the monitoring method, when executed on a computer.

### BACKGROUND OF THE INVENTION

It is known that vital functions of different platforms are controlled by means of hydraulic systems. For example, in the field of aviation, airplanes are provided with at least one hydraulic system being used for controlling e.g. control surfaces, landing gears or air brakes. It is common to have two separate, independent hydraulic systems, so as to provide redundancy. Each hydraulic system is associated with a hydraulic pump powered by for example a motor of the platform via a gear box.

In aircrafts, in particular during flights, it is of outmost importance that provided hydraulic pumps function properly. A failing hydraulic pump is hazardous, even if a back-up hydraulic system is provided within the platform.

Today there exist various methods relating to monitoring of hydraulic systems. For example, the document DE 10334817 depicts a device for monitoring of a pump. The pump is provided with a pressure sensor arranged to measure the pressure of the pump. Detected pressure data is sampled and subsequently Fourier-transformed.

EP 1679365 discloses a device for monitoring a pump, for example arranged for a vehicle brake. Detected pressure data is sampled and subsequently Fourier-transformed. Frequencies of pressure pulsations are compared with reference frequencies of a properly functioning pump.

Both DE 10334817 and EP 1679365 involve Fourier-transformation which is associated with a heavy computational burden.

It therefore exist a need to provide an arrangement capable to detect malfunctioning hydraulic pumps at an early stage within a platform, such as an airplane, while minimizing computational burden.

### SUMMARY OF THE INVENTION

An object of the invention according to an aspect of the invention is to provide an improved arrangement and method for monitoring of a hydraulic pump.

Another object of the invention according to an aspect of the invention is to provide an arrangement and method for detecting a malfunctioning hydraulic pump at an early stage.

Yet another object of the invention according to an aspect of the invention is to provide an arrangement and method for detecting a malfunctioning hydraulic pump while reducing the computational burden.

Yet another object of the invention according to an aspect of the invention is to achieve a robust and reliant arrangement and method for detecting a malfunctioning hydraulic pump at an early stage.

Above mentioned problems are solved by an arrangement for monitoring a supply means within a platform, the arrangement comprising:
sensor means being arranged to generate sample values relating to a fluid characteristic variable, wherein said fluid is fed by the supply means within the platform;
processing means being arranged to receive a plurality of sample values from said sensor means,
wherein the processing means is arranged to generate an absolute value of a difference between each of said received plurality of sample values and a respective associated sample value, wherein said received sample values are generated during a predetermined time period, and
the processing means is arranged to determine an indication number corresponding to the number of said generated absolute values which are greater than a predetermined threshold value, wherein
the processing means is arranged to generate a piece of indication information depending upon a result of a comparison between said determined indication number and a predetermined comparison value.

Preferably the supply means is a hydraulic pump, such as a hydraulic pump. Preferably the fluid is a hydraulic fluid.

Preferably the fluid characteristic variable is a hydraulic fluid characteristic variable chosen from a group comprising hydraulic fluid pressure and a hydraulic fluid flow. Preferably the respective associated sample value is a subsequent sample value.

Preferably the processing means is arranged to store the piece of indication information in a memory so as to allow a user to access said indication information.

Preferably the piece of indication information comprising information about a state of condition of said supply means.

Preferably the information about a state of condition comprises information about that the supply means is malfunctioning.

Preferably the indication means is arranged to generate a fault report after a predetermined time or substantially instantaneous depending upon a result of the comparison between said determined indication number and a predetermined comparison value.

The invention also relates to a platform comprising above mentioned arrangement. Preferably the platform is an aircraft, e.g. an airplane. Alternatively, the platform is a ground vehicle, water craft or underwater craft, automobile, ship or submarine.

According to an aspect of the invention the number of hydraulic variable data, such as pressure samples, whose amplitude differs from a magnitude of a preceding hydraulic variable data more than a predetermined value (aperture), within a time window, is registered. The number of counted hydraulic variable data according to the given criterion is compared with a predetermined number (set value). An indication of a malfunctioning pump is generated if the number of registered hydraulic variable data is larger than or equal to the predetermined number (set value). Thus the model according to the invention is based upon statistics.

The arrangement for monitoring the hydraulic pump is active during a stand-by state of condition, i.e. a state of rest. In other words, a state where sub-systems of the hydraulic system of the platform only require a hydraulic fluid flow which is insignificantly larger than a leakage flow within a respective hydraulic consumer. Monitoring during a state of rest, for example during taxation of an airplane on ground before take-off or during cruise, is a convenient and safe implementation of the invention.

One positive outcome of the arrangement and method according to the invention is that no extra hardware components are needed to be installed in aircrafts of today. Existing sensors and data processing units may be used for realising the invention.

The solution according to the invention is not based on analysis of frequency domain and therefore refers to another methodology. Fast Fourier Transform (FFT) analysis is not required to achieve an early indication of a malfunctioning hydraulic pump.

Advantageously the method and system according to the invention does not require continuously high sample frequencies, which is required in FFT-implementations according to prior art. Further, method according to the invention does not require pressure sensors providing high break frequency. Even further, the method and system does not require time equidistant samples for further processing, so as to monitor a hydraulic system.

It should be noted that there is required a small amount of data samples, and a minimum of variables to successfully monitor a hydraulic pump according to the invention.

Advantageously program code comprising routines for monitoring a hydraulic system easily can be implemented in platforms of today, thus providing a cheap and efficient upgrading possibility of a platform fleet.

The invention can advantageously be implemented for both main hydraulic pumps and back-up hydraulic pumps.

Preferably the method of monitoring a hydraulic pump is performed on-line. Preferably the method of monitoring a hydraulic pump is performed on-line on-board the platform.

The present invention further provides an improved ability to early detect a malfunctioning individual pump, which reduces the risk for pump breakdown in air or during driving of the platform. Improved safety of platforms is highly desirable, not at least for the operators thereof.

A beneficial contribution of the invention is that a cost effective solution to the above stated problems is achieved. Expensive hardware replacements implied by pump failures are avoided or reduced. Further, maintenance of the platform is facilitated and the availability of the platform is highly increased, which also contribute to lower overall costs of the platform. Replacement of failured pump can also be done during scheduled maintenance.

Yet another beneficial contribution of the invention is that the system and method for monitoring the hydraulic pump is robust, meaning that false alarms are reduced, which also reduces the stress for the operator of the platform.

The invention can be retro modified in existing aircraft fleet, which in some cases has very simple computer systems with limited CPU and memory capacities. This benefit opens up for a big civil market in the field of health monitoring.

According to an aspect of the invention there is provided a device at a hydraulic pump arranged to detect malfunctioning of the pump, wherein the device comprises:
calculating means arranged to, during a predetermined time interval, determine a number of samples, of which amplitude differ more than a first predetermined value from the amplitude of a preceding sample, and if the number of established number of samples exceeds a second predetermined value there is detected that the pump is malfunctioning.

Preferably the samples are pressure samples.

According to an aspect of the invention there is provided a control unit arranged to control activation of the aforementioned device so that activation only is possible when pump operation is in a stand-by state, or an idle state.

Additional objects, advantages and novel features of the present invention will become apparent to those skilled in the art from the following details, as well as by practice of the invention. While the invention is described below, it should be understood that the invention is not limited to the specific details disclosed. A person skilled in the art having access to the teachings herein will recognise additional applications, modifications and embodiments in other fields, which are within the scope of the invention.

### BRIEF DESCRIPTION OF THE DRAWINGS

For a more complete understanding of the present invention and further objects and advantages thereof, reference is now made to the examples shown in the accompanying drawings, in which:

FIG. 1a schematically illustrates a platform according to an aspect of the present invention.

FIG. 1b schematically illustrates a sub-system of the platform of FIG. 1a according to an aspect of the present invention;

FIG. 2a schematically illustrates a hydraulic system of a platform according to an aspect of the present invention;

FIG. 2b schematically illustrates hydraulic system of a platform according to an aspect of present invention;

FIG. 3a schematically illustrates a graph according to an aspect of the present invention;

FIG. 3b schematically illustrates graph in more detail according to an aspect of the present invention;

FIG. 3c schematically illustrates graph in more detail according to an aspect of the present invention;

FIG. 4a schematically illustrates a flow chart depicting a method for monitoring a hydraulic pump according to an aspect of the present invention;

FIG. 4b schematically illustrates in greater detail a flow chart depicting a method monitoring a hydraulic pump according to an aspect of the present invention;

FIG. 5 schematically illustrates a data processing unit according to an aspect of the invention;

FIG. 6 schematically illustrates a logic structure depicting a stand-by state.

### DETAILED DESCRIPTION OF THE DRAWINGS

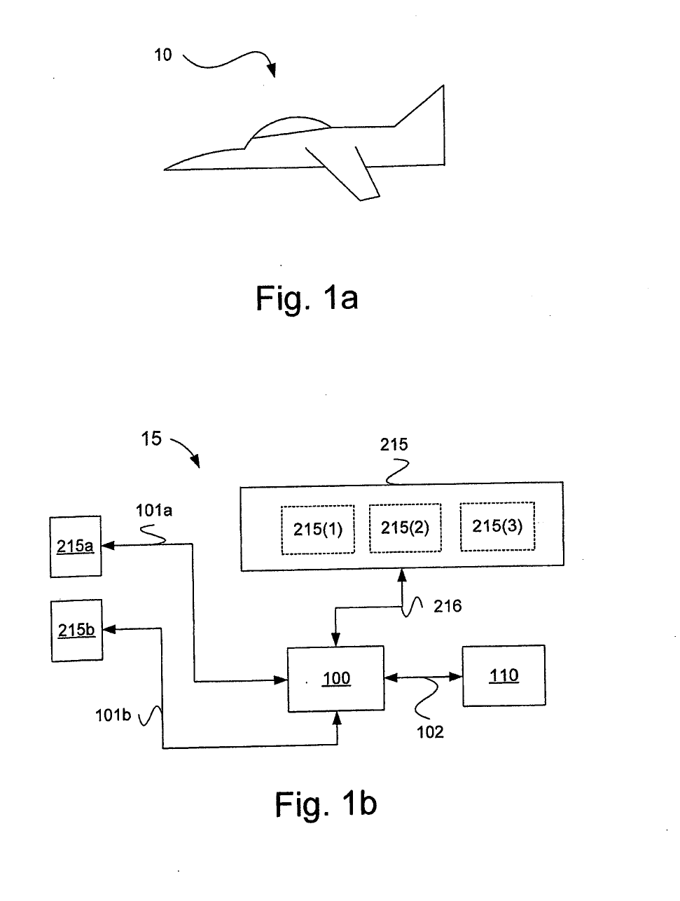

With reference to FIG. 1a a platform 10 is schematically shown. The platform may be an airplane, such as a passenger traffic airplane. Alternatively the airplane can be a military aircraft, such as a fighter, bomber, reconnaissance airplane, or a combination thereof. The platform may also be an autonomous platform, such as an unmanned aerial vehicle (UAV). The autonomous platform can also be any kind of a helicopter, robot or missile.

Herein, for sake of simplicity, the arrangement and method for monitoring of a hydraulic system according to the invention is depicted for the case of the platform being an airplane controlled by a pilot. However, various different applications of the arrangement are possible, e.g. for use of remote controlled vehicles such as helicopters.

It should be noted that the platform 10 alternatively can be a ground vehicle, water craft or underwater craft, e.g. an automobile, ship or submarine. Alternatively, the platform 10 can be a space craft. The platform 10 comprises a sub-system, which is depicted in greater detail below with reference to FIG. 1b.

Hereinafter the term “link” refers to a communication link which may be a physical connector, such as an optoelectronic communication wire, or a non-physical connector such as a wireless connection, for example a radio or microwave link.

FIG. 1b schematically illustrates the above mentioned sub-system 15 of the platform 10. The sub-system 15 comprises a data processing unit 100. The data processing unit 100 is arranged for communication with a communication terminal 110 via a link 102. The communication terminal 110 may be a monitor, touch-screen, acoustic communication means, such as a loudspeaker, visible communication means, such as a signalling lamp, etc, or a combination thereof. The communication terminal 110 is preferably provided in a cockpit of the platform 10. The communication terminal 110 is arranged to allow an operator of the platform 10 to interact with the data processing unit 100 by means of a communications terminal 110. The communications terminal 110 is according to one embodiment of the invention provided with a suitable user interface IF.

A first sensor unit 215a is arranged for communication with the data processing unit 100 via a link 101b. A second sensor unit 215b is arranged for communication with the data processing unit 100 via a link 101b.

Also shown in FIG. 1b is a set of sensors 215 comprising three independent sensor units 215(1), 215(2) and 215(3). According to an embodiment of the invention the set of sensors 215 comprises an arbitrary number N of independent sensors 215(1)-215(N). The set of sensors 215 is arranged for communication with the data processing unit 100 via a link 216.

According to a preferred embodiment of the invention the sensor units 215a, 215b, 215(1), 215(2) and 215(3) are arranged to measure a hydraulic system variable. Examples of hydraulic system variables are: momentaneous pressure P [Pa] and flow [m³/s] of the hydraulic fluid.

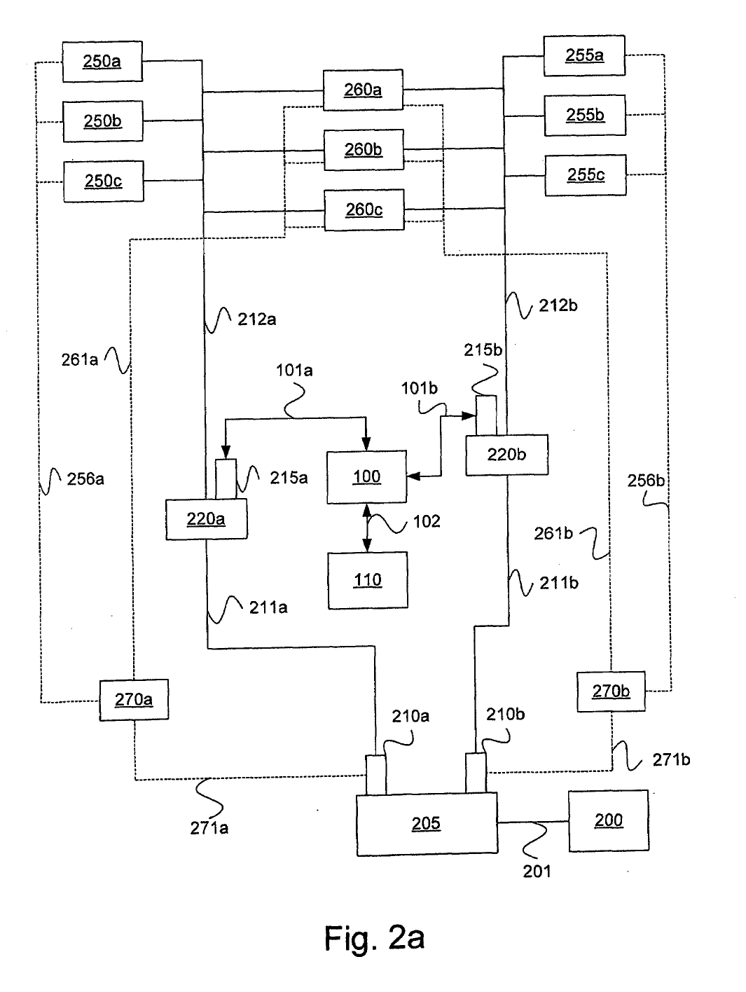

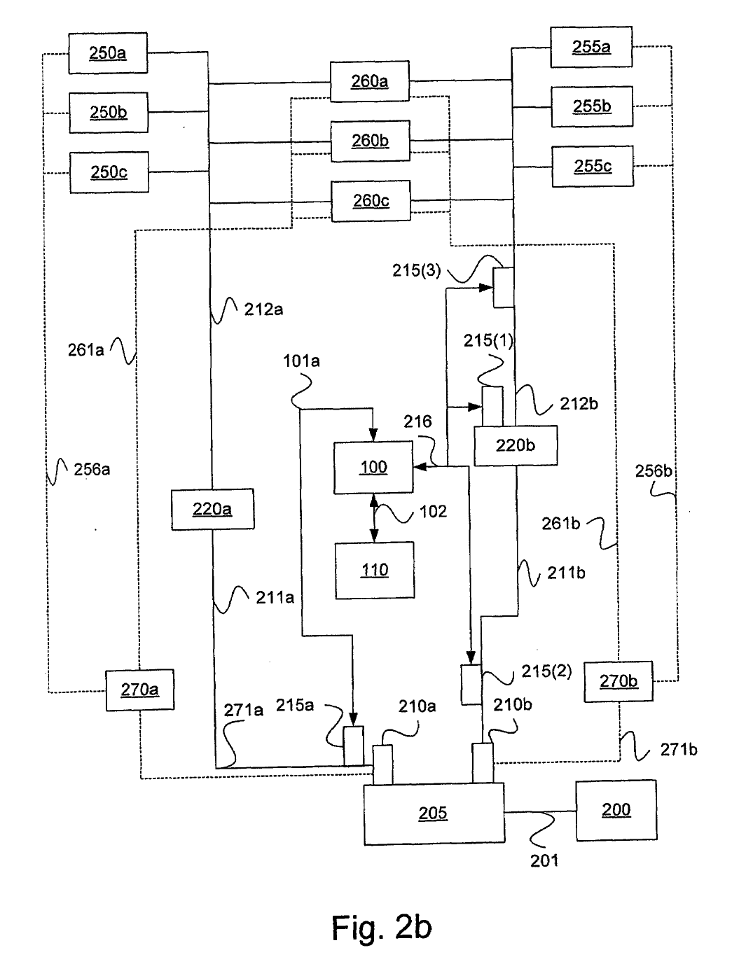

FIG. 2a schematically illustrates an overview of a hydraulic system provided within an aircraft 10.

An airplane engine, such as a jet engine, is denoted motor 200. The motor 200 is coupled to a gearbox 205 via a shaft 201. The gearbox 205 can be a two stage gear box, The gearbox 205 is arranged to transmit force to a first hydraulic pump 210a. Thus, the motor 200 is arranged to power a first hydraulic pump 210a via the gearbox 205.

The pump can also be attached directly to the engine.

According to one embodiment of the invention the first hydraulic pump 210a is for example an axial piston pump. However, any suitable hydraulic pump may be used.

The hydraulic pump 210a is arranged to generate a hydraulic press and flow through a first hydraulic fluid upstream pipe 21 la to a valve unit 220a. The valve unit 220a is provided with an outlet to which a second hydraulic fluid upstream pipe 212a is connected. The second hydraulic fluid upstream pipe 212a is coupled to a number of hydraulic sub-system units 250a, 250b and 250c. Also, the second hydraulic fluid upstream pipe 212a is coupled to a number of common hydraulic sub-system units 260a, 260b, and 260c.

The number of hydraulic sub-system units is arbitrary. For sake of simplicity there is only illustrated a fuel transfer pump 250a, landing gear main module 250b and a main brake module 250c. Other examples of hydraulic sub-system units are a refueling module and a steering module. The hydraulic sub-system units 250a, 250b and 250c are connected to a hydraulic fluid reservoir 270a via a hydraulic fluid downstream pipe 256a.

The number of common hydraulic sub-system units is arbitrary. For sake of simplicity there is only illustrated a rudder module 260a, left canard module 260b, and right canard module 260c. Other examples of common hydraulic sub-system units are examples of hydraulic sub-system units are a refueling module and a steering module. The common hydraulic sub-system units 260a, 260b and 260c are connected to the hydraulic fluid reservoir 270a via a hydraulic fluid downstream pipe 261a.

The hydraulic fluid reservoir 270a is coupled to the first hydraulic pump 210a via a reservoir pipe 271a.

It should be noted that the first hydraulic pump 210a is arranged to generate the hydraulic fluid pressure and flow through the first hydraulic fluid upstream pipe 211a, valve unit 220a, second hydraulic fluid upstream pipe 212a, to subsequently supply at least one hydraulic subsystem unit 250a, 250b, 250c and/or at least one common hydraulic subsystem unit 260a, 260b, 260c. Thereafter the fluid is transferred back to the first hydraulic pump 210a via the hydraulic fluid downstream pipe 256a or 261a, respectively, hydraulic fluid reservoir 270a and the reservoir pipe 271a. The hydraulic fluid is provided within a closed system.

A first sensor unit 215a is provided at the first valve unit 220a. The first sensor unit 215a is arranged to measure pressure P1a of the hydraulic fluid HF within the valve unit 220a. The first sensor unit 215a is arranged to measure the pressure P1a in a time discrete manner. The first sensor unit 215a arranged for communication with a data processing unit 100 via a first sensor link 101a. The first sensor unit 215a is arranged to send measured pressure data P1a to the processing unit 100.

The hydraulic system of the platform 10 further comprises a second sub-system. The second hydraulic sub-system comprises a second hydraulic pump 210b, which is powered by the motor 200 via shaft 201 and gearbox 205. The second hydraulic pump 210b is arranged to pump the hydraulic fluid HF2 through a first hydraulic fluid upstream pipe 211b, valve unit 220b, second hydraulic fluid upstream pipe 212b, to subsequently actuate at least one hydraulic subsystem unit 255a, 255b, 255c and/or at least one common hydraulic subsystem unit 260a, 260b, 260c. Thereafter the hydraulic fluid HF is transferred back to the second hydraulic pump 210b via a hydraulic fluid downstream pipe 256b or 261b, respectively, hydraulic fluid reservoir 270b and a reservoir pipe 27 lb. The hydraulic fluid is provided within a closed system. The second sensor unit 21 Sb is arranged for communication with the data processing unit 100 via a second sensor link 101b.

According to this embodiment the subsystem unit 255a is an air brake module. The subsystem unit 255b is a gun ventilation unit. The subsystem unit 255c is a landing gear module. It should be noted that the number of hydraulic subsystem units are arbitrary, depending upon e.g. type of platform and internal configuration of the same. For sake of clarity only three different examples of hydraulic subsystem units are shown herein.

The common hydraulic subsystem unit 260a, 260b, 260c are actuated by both the first hydraulic sub-system and the second hydraulic sub-system. According to one embodiment the first hydraulic sub-system and the second hydraulic sub-system are mutually independent, i.e. the first hydraulic fluid HF1 and the second hydraulic fluid HF2 are not mixed.

The data processing unit 100 is arranged for communication with a communications terminal 110 via a link 102. The communications terminal is depicted in greater detail with reference to FIG. 1b.

The data processing unit is arranged to calculate a number of stored pressure sample per unit time, e.g. minute.

Monitoring of at least one of the first and second hydraulic pumps is performed during for example flying wings-level in cruise mode, namely when the rudders in principle are non-moving and no other activities in the hydraulic system are commanded. The monitor is in active mode during these circumstances. A normally functioning hydraulic pump is during these circumstances providing a stable pressure, where no ripple is generated. However, a malfunctioning hydraulic pump is during these circumstances generating different types of significant pressure ripple, even during flying wings-level. If pressure samples are determined to be fluctuating given a predetermined criterion, samples are stored in an internal memory of the data processing unit. The data processing unit is arranged to generate a report signal if the number of recorded pressure samples exceed a predetermined number per unit time. This makes the monitoring function according to the invention robust and simple.

FIG. 2b schematically illustrates an overview of an alternative hydraulic system provided within an aircraft 10.

With reference to FIG. 2b there is illustrated that the first sensor unit 215a is arranged at the first hydraulic pump 210a instead of at the valve unit 220a as shown in FIG. 2a. The first sensor unit 215a is arranged to measure pressure P1a of the hydraulic fluid HF at an outlet of the first hydraulic pump 210a.

According to an alternative embodiment of the invention the first sensor unit 215a is arranged to measure the pressure of the hydraulic fluid HF within the second upstream pipe 212a. It should be noted that the hydraulic fluid HF is provided within a closed system, and therefore the first sensor unit 215a could be placed at various locations suitable for providing relevant pressure data P1a to the data processing unit 100.

According to one embodiment of the invention

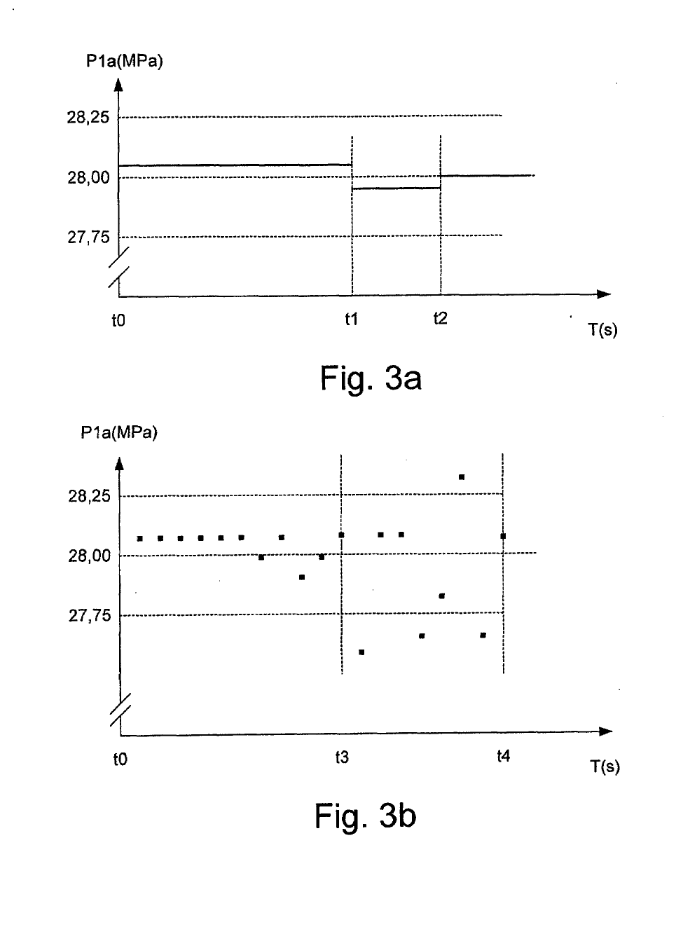

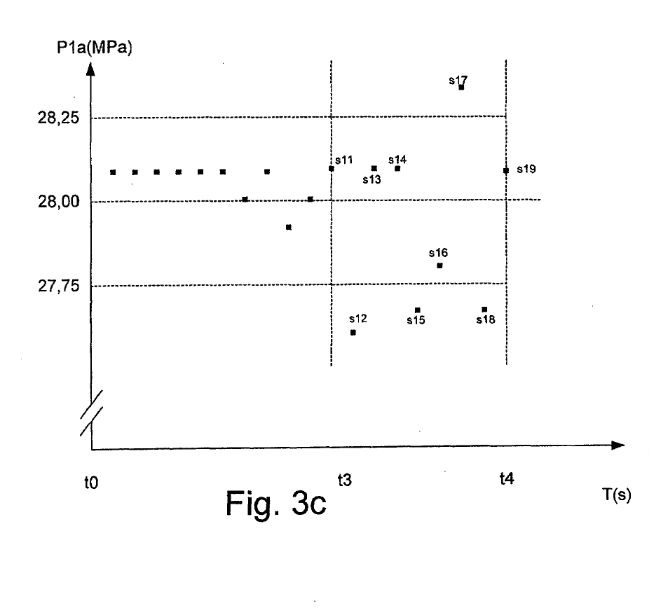

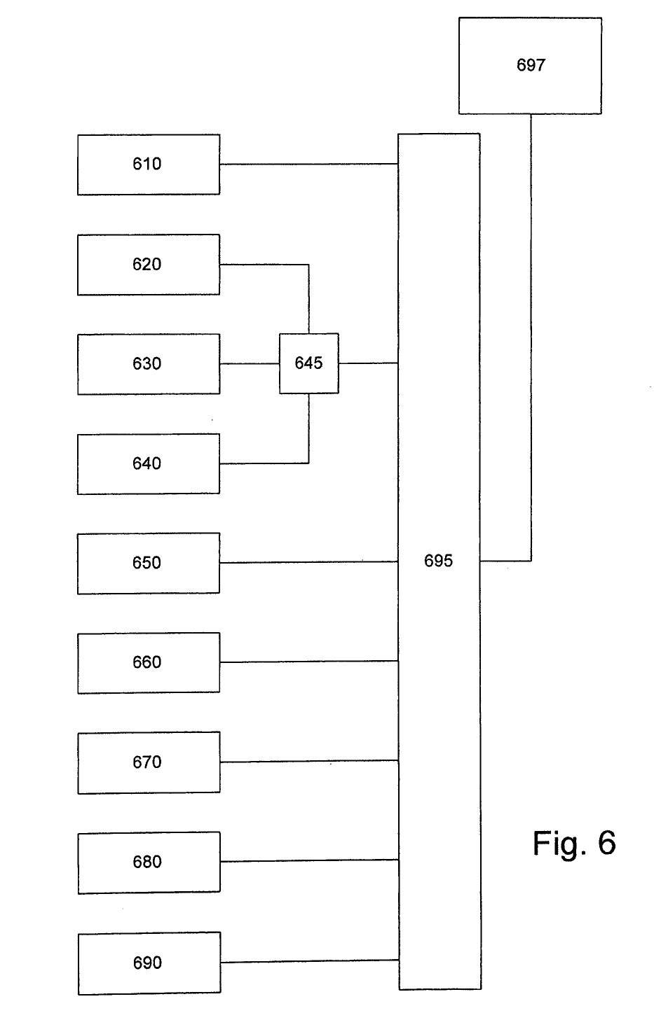

In FIG. 3a, 3b and 3c the active monitor criterion is fulfilled, which is depicted in greater detail with reference to FIG. 6.

FIG. 3a is a graph wherein detected hydraulic pressure P1a is plotted as a function of time T. Herein a should-value of the hydraulic pressure P1a is set for example to 28.00 MPa. A desired value of the hydraulic pressure P1a of the hydraulic system is thus 28.00 MPa. As can be seen the value of P1a is substantially 28.00 MPa during the time interval t0-t2 indicating that the first hydraulic pump 210a is functioning properly, i.e. no tendency of malfunctioning of the pump is indicated. The registered values of P1a between the time starting point t0 and the time point t1 is slightly higher than the should-value 28.00 MPa. It is also seen that registered values of P1a between the time point t1 and the time point t2 is slightly lower than the set value 28.00 MPa. It is also seen that registered values of P1a are substantially 28.00 MPa for time values larger than t2. It should be noted that registered pressure values P1a are within a predetermined range, namely within an interval 27.75 and 28.25 MPa. FIG. 3a depicts a normal state of condition of the hydraulic pump 210a.

FIG. 3b depicts in greater detail samples of measured hydraulic pressure P1a wherein malfunctioning of the hydraulic pump is detected within a time interval t3-t4. It is illustrated that some subsequent samples differ more than for example 0.25 MPa and is therefore indicating that the hydraulic pump 210a is not in a normal or desired state of condition.

FIG. 3c depicts in greater detail samples, for example samples s11-s19 within the time interval t3-t4, of measured hydraulic pressure P1a with reference to FIG. 3b. It is illustrated that
   |s11-s12|≧0.25 MPa;|s12-s13|≧0.25 MPa;|s14-s15|≧0.25 MPa;
   |s16-s17|≧0.25 MPa;|s17-s18|≧0.25 MPa;|s18-s19|≧0.25 MPa.

It is also illustrated that |s13-s14|≧0.25 MPa;|s15-s16|≧0.25 MPa.

According to an aspect of the invention the number of absolute values of two subsequent pressure values, which are greater than or equal within a predetermined time interval that exceeds a predetermined threshold value, are taken into consideration when determining whether a hydraulic pump is malfunctioning or not.

In the example depicted with reference to FIG. 3c there are six absolute values of two subsequent pressure values which are greater than or equal 0.25 MPa within a predetermined time interval t3-t4. Also, during the predetermined time interval t3-t4 there are two absolute values of two subsequent pressure values, which are less than 0.25 MPa within the same predetermined time interval t3-t4.

By calculating the number of absolute values of two subsequent pressure values which are greater than a predetermined time period an indication value IV may be calculated. The value IV represents an indication of a condition of the monitored hydraulic pump. A high value of the indication value signifies a significant ripple of the measurements. The value IV may be expressed in pressure sample per minute.

There is provided a threshold level L, which is a predetermined value. If the indication value IV exceeds the threshold level L

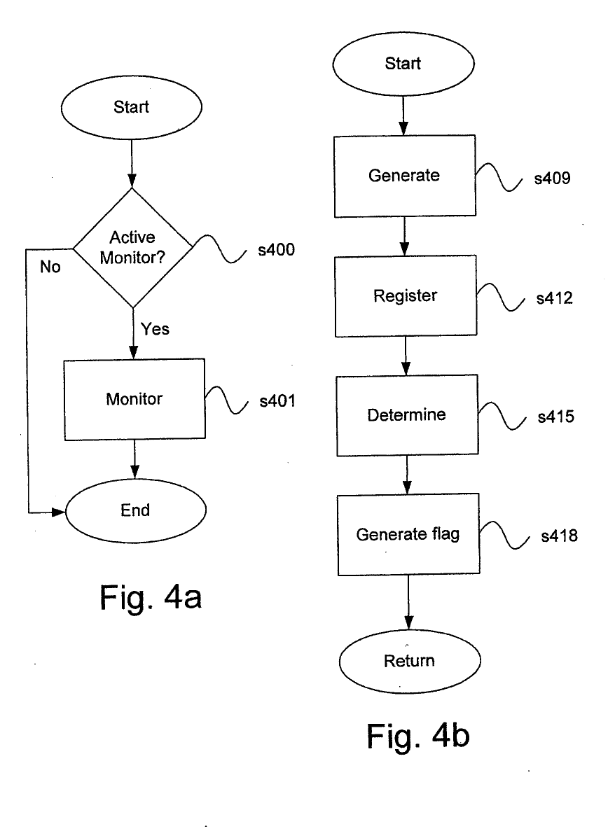

FIG. 4a schematically illustrates a method for monitoring a hydraulic pump within a platform. The method comprises two steps. The first step s400 comprises the step of determining whether a state of active monitoring is set. If the state of active monitoring is provided, a second step s401 is performed. If the state of active monitoring is not provided the method ends.

The second step s400 comprises the sub-steps of:
determining whether the active monitor criterion is fulfilled;
generating sample values relating to a hydraulic fluid characteristic variable,
wherein said fluid is fed by the hydraulic pump within the platform;
receiving a plurality of sample values from said sensor means;
generating an absolute value of a difference between each of said received plurality of sample values and a subsequent associated sample value, wherein said received sample values are generated during a predetermined time period;
determining an indication number corresponding to the number of said generated absolute values which are greater than a predetermined threshold value; and
generating a piece of indication information depending upon a result of a comparison between said determined indication number and a predetermined comparison value.

The predetermined value is preferably a threshold value. The threshold value depends on the system characteristic. The thresholds can be multiple.

Monitor is active when a criterion comprising a stable pump in a no load condition and all hydraulic consumers are in a resting position or close to a resting position is fulfilled. Hydraulic consumers can be hydraulic valves for surface actuating, landing gear maneuvering or air brakes.

After the method step s401 the method ends.

Preferably the method comprises the step of:
generating sample values relating to a hydraulic fluid characteristic variable, wherein the fluid characteristic variable is a hydraulic fluid characteristic variable chosen from a group comprising hydraulic fluid pressure and a hydraulic fluid flow.

Preferably the method comprises the step of:
storing the piece of indication information in a memory so as to allow a user to access said indication information.

Preferably the method comprises the step of:
generating a fault report after a predetermined time or substantially instantaneous depending upon a result of the comparison between said determined indication number and a predetermined comparison value.

FIG. 4b schematically illustrates in greater detail a method for early detection of faults of a hydraulic pump onboard a platform.

The method comprises a first method step s409. The method step s409 comprises the steps of:
continuously generating samples of hydraulic fluid variable which is indicative of a hydraulic pump status condition, wherein the hydraulic fluid variable for example is a hydraulic fluid pressure;
sending said generated samples to a processing means. After the method step s409 a subsequent method step s412 is performed.

The method step s412 comprises the steps of:
receiving said generated samples;
register at least some samples according to a predetermined criterion. After the method step s412 a subsequent method step s415 is performed.

The method step s41 5 comprises the step of:
determining a number of received sample values which fulfil a predetermined criterion. The received sample values are belonging to a time period when the monitor is active, for example 10 minutes during taxiing on ground, or 5 minutes during idling of the platform. The monitor can be active for several times during a flight. An example of the predetermined criterion is that a sample value is counted if it deviates from a set value, for example 28 MPa, more than an aperture value (for example 0.25 MPa). According to another embodiment a sample value is only counted if an absolute value of the difference between the sample value of interest and a subsequent sample value differs more than a threshold value.

After the method step s415 a subsequent method step s418 is performed. The method step s418 comprises the steps of: generating at least one flag. The process of determining levels for setting monitoring flags is based on the process of filtering a pressure signal and aperture limits. The aperture is in turn adapted to a characteristic of a hydraulic pump, so that changes of pressure measurements, while the system is in stand-by state, or in idle state, do not give rise to pressure samples which are counted by the monitor.

Also, the process of determining levels for setting monitoring flags is based on the characteristics of the pump in stand-by region, i.e. when the necessary flow of fluid is low, e.g. in the case of an airplane, only a few litres/minute. Thereafter the method ends.

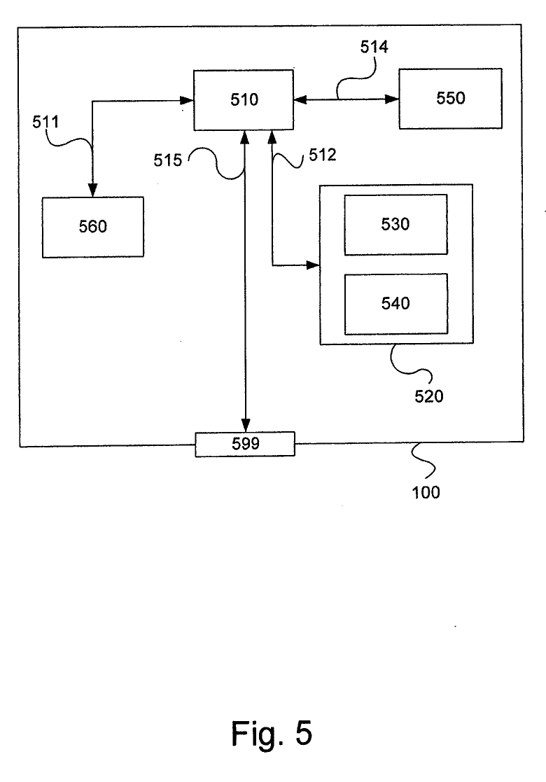

With reference to FIG. 5, a diagram of one embodiment of the apparatus 100 is shown. Apparatus 100 comprises a non-volatile memory 520, a data processing device 510 and a read/write memory 550. Non-volatile memory 520 has a first memory portion 530 wherein a computer program, such as an operating system, is stored for controlling the function of apparatus 100. Further, apparatus 100 comprises a bus controller, a serial communication port, I/O-means, an A/D-converter, a time date entry and transmission unit, an event counter and an interrupt controller (not shown). Non-volatile memory 520 also has a second memory portion 540.

A computer program comprising routines for monitoring of a hydraulic pump onboard a platform, which data is generated by sensors units according to the invention. The program may be stored in an executable manner or in a compressed state in a separate memory 560 and/or in read/write memory 550.

When it is stated that data processing device 510 performs a certain function it should be understood that data processing device 510 performs a certain part of the program which is stored in separate memory 560, or a certain part of the program which is stored in read/write memory 550.

Data processing device 510 may communicate with a data port 599 by means of a data bus 515. Non-volatile memory 520 is adapted for communication with data processing device 510 via a data bus 512. Separate memory 560 is adapted to communicate with data processing device 510 via a data bus 511. Read/write memory 550 is adapted to communicate with data processing device 510 via a data bus 514.

When data is received on data port 599 it is temporarily stored in second memory portion 540. When the received input data has been temporarily stored, data processing device 510 is set up to perform execution of code in a manner described above. According to one embodiment, data received on data port 599 comprises information such as input signals provided by the sensors 215a, 215b or the set of sensors 215. This information can be used by apparatus 100 so as to identify if a hydraulic pump onboard the platform is malfunctioning.

Parts of the methods described herein can be performed by apparatus 100 by means of data processing device 510 running the program stored in separate memory 560 or read/write memory 550. When apparatus 100 runs the program, parts of the methods described herein are executed.

An aspect of the invention relates to a computer programme comprising a programme code for performing the method steps depicted with reference to FIG. 4a and 4b, respectively, when the computer programme is run on a computer.

An aspect of the invention relates to a computer programme product comprising a program code stored on computer-readable media for performing the method steps depicted with reference to FIG. 4a and 4b, respectively, when the computer programme is run on the computer.

An aspect of the invention relates to a computer programme product directly storable in an internal memory of a computer, comprising a computer programme for performing the method steps depicted with reference to FIG. 4a and 4b, respectively, when the computer programme is run on the computer.

FIG. 6 schematically illustrates a logic structure depicting a stand-by state configuration according to an embodiment of the invention.

A unit 610 represents a condition where a derivative of a commanded control of at least one control surface is strictly less than a predetermined number of degrees/seconds during a predetermined time period.

A unit 620 represents a condition of, during operational phase: Flying with landing gear retracted.

A unit 630 represents a condition of, during operational phase: Parked airplane with a running engine.

A unit 640 represents a condition of, during operational phase: Taxation of the airplane.

A unit 650 represents a condition of not commanding air brakes.

A unit 660 represents a condition of not commanding High Lift System/Leading Edge Flap System.

A unit 670 represents a condition of not commanding hydraulic supplied fuel transfer pump(s), if at least one control signal is provided on relevant data bus.

A unit 680 represents a condition of not commanding remaining hydraulic sub systems, if at least one control signal is provided on relevant data bus.

A unit 690 represents a condition where no warning flags from control- or hydraulic system affecting stand by-/idle position are provided.

The unit 645 is an “OR”-functioning unit, such as an OR-gate.

The unit 695 is an “AND”-functioning unit, such as an AND-gate.

Thus, if at least one condition associated with the units 620, 630 or 640 is true this condition is provided to the unit 695 via the unit 645. If all conditions associated with the units 610, 645, 650, 660, 670, 680, and 690 hold true a state of active monitoring also holds true (unit 697). If a condition of active monitoring associated with the unit 697 holds true this means that the hydraulic pump is in stand-by or idle position.

It should be noted that various forms the logic structure depicting a stand-by state configuration may be implemented.

The scope of the invention is not limited to hydraulic fluid systems, other applications includes fuel systems and cooling systems. It should be noted that the method according to the invention also is applicable to fluid systems, i.e. systems which involve e.g. water.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. An arrangement for monitoring a supply within a platform, the arrangement comprising:
a sensor arranged to generate sample values relating to a fluid characteristic variable, wherein said fluid is fed by the supply within the platform; and
a processor arranged to receive a plurality of sample values from said sensor,
wherein the processor is arranged to generate an absolute value of a difference between each of said received plurality of sample values and a subsequent associated sample value, wherein said received sample values are generated during a predetermined time period, and
wherein the processor is arranged to determine an indication number corresponding to the number of said generated absolute values which are greater than a predetermined threshold value, and
wherein the processor is arranged to generate a piece of indication information depending upon a result of a comparison between said determined indication number and a predetermined comparison value.

2. The arrangement according to claim 1, wherein the supply means is comprises a hydraulic pump.

3. The arrangement according to claim 1, wherein the fluid comprises a media chosen from a group comprising oil and water.

4. The arrangement according to claim 1, wherein the fluid characteristic variable comprises a hydraulic fluid characteristic variable chosen from a group comprising hydraulic fluid pressure, or hydraulic fluid flow.

5. The arrangement according to claim 1, wherein the respective associated sample value comprises a subsequent sample value.

6. The arrangement according to claim 1, wherein the processor is arranged to store the piece of indication information in a memory so as to allow a user to access said indication information.

7. The arrangement according to claim 1, wherein the piece of indication information comprises information about a state of condition of said supply.

8. The arrangement according to claim 7, wherein the information about a state of condition comprises information whether the supply is malfunctioning.

9. The arrangement according to claim 1, further comprising:
an indicator arranged to generate a fault report after a predetermined time or substantially instantaneous depending upon a result of the comparison between said determined indication number and a predetermined comparison value.

10. A platform, comprising
an arrangement for monitoring a supply within a platform, the arrangement comprising:
a sensor arranged to generate sample values relating to a fluid characteristic variable, wherein said fluid is fed by the supply within the platform, and
a processor arranged to receive a plurality of sample values from said sensor,
wherein the processor is arranged to generate an absolute value of a difference between each of said received plurality of sample values and a subsequent associated sample value,
wherein said received sample values are generated during a predetermined time period, and wherein the processor is arranged to determine an indication number corresponding to the number of said generated absolute values which are greater than a predetermined threshold value, and
wherein the processor is arranged to generate a piece of indication information depending upon a result of a comparison between said determined indication number and a predetermined comparison value.

11. The platform according to claim 10 wherein the platform comprises a mobile platform chosen from a group comprising an aircraft, ground vehicle, water craft or underwater craft.

12. The platform according to claim 10, wherein the platform comprises a stationary platform.

13. A method for monitoring a hydraulic pump within a platform, the method comprising:
generating sample values relating to a hydraulic fluid characteristic variable, wherein said fluid is fed by the hydraulic pump within the platform;
receiving a plurality of sample values from said sensor means a sensor,
generating an absolute value of a difference between each of said received plurality of sample values and a subsequent associated sample value, wherein said received sample values are generated during an active monitor period,
determining an indication number corresponding to the number of said generated absolute values which are greater than a predetermined threshold value, and
generating a piece of indication information depending upon a result of a comparison between said determined indication number and a predetermined value.

14. The method according to claim 13, further comprising:
generating sample values relating to a hydraulic fluid characteristic variable, wherein the fluid characteristic variable is a hydraulic fluid characteristic variable chosen from a group comprising hydraulic fluid pressure and hydraulic fluid flow.

15. The method according to claim 13, further comprising:
storing the piece of indication information in a memory so as to allow a user to access said indication information.

16. The method according to claim 13, further comprising:
generating a fault report after a predetermined time or substantially instantaneous depending upon a result of the comparison between said determined indication number and a predetermined threshold value.

17. A computer program product, comprising
a computer readable medium; and
computer program instructions recorded on the computer readable medium and executable by a processor for performing a method for monitoring a hydraulic pump within a platform, the method comprising:
generating sample values relating to a hydraulic fluid characteristic variable, wherein said fluid is fed by the hydraulic pump within the platform:
receiving a plurality of sample values from a sensor,
generating an absolute value of a difference between each of said received plurality of sample values and a subsequent associated sample value, wherein said received sample values are generated during an active monitor period,
determining an indication number corresponding to the number of said generated absolute values which are greater than a predetermined threshold value, and
generating a piece of indication information depending upon a result of a comparison between said determined indication number and a predetermined value.

18. (canceled)

19. (canceled)

20. A device at a hydraulic pump arranged to detect malfunctioning of the pump, the device comprising:
a calculator arranged to, during a predetermined time interval, determine a number of samples, of which amplitude differ more than a first predetermined value from the amplitude of a preceding sample, and if the number of established number of samples exceeds a second predetermined value there is detected that the pump is malfunctioning.

21. The device according to claim 20, wherein the samples comprises pressure samples.

22. A control unit arranged to control activation of a device at a hydraulic pump arranged to detect malfunctioning of the pump, the device comprising a calculator arranged to, during a predetermined time interval, determine a number of samples, of which amplitude differ more than a first predetermined value from the amplitude of a preceding sample, and if the number of established number of samples exceeds a second predetermined value there is detected that the pump is malfunctioning, wherein the control only activates the device when pump operation is in a stand-by state, or an idle state.

23. The arrangement according to claim 1, wherein the fluid comprises a hydraulic oil.

24. The platform according to claim 10, wherein the platform comprises a mobile platform selected from the group comprising an airplane, automobile, ship or submarine.

25. The platform according to claim 10, wherein the platform comprises a pulp machine or steel press.
